(19) United States
(12) Patent Application Publication
(10) Pub. No.: US 2025/0390744 A1
(43) Pub. Date: Dec. 25, 2025

(54) Data Classification Models Using Feature Extraction and Clustering

(71) Applicant: Proofpoint Inc., Sunnyvale, CA (US)

(72) Inventors: Christopher MUFFAT, Singapore (SG); Tetiana KODLIUK, Singapore (SG)

(21) Appl. No.: 19/263,076

(22) Filed: Jul. 8, 2025

Related U.S. Application Data
(63) Continuation of application No. 16/731,259, filed on Dec. 31, 2019, now abandoned.

(30) Foreign Application Priority Data
Dec. 31, 2018 (SG) 10201811839R

(51) Int. Cl. G06N 3/08; G06F 18/24; G06F 18/2415; G06F 18/2431; G06N 3/04

(52) U.S. Cl. CPC G06N 3/08; G06F 18/24; G06F 18/24155; G06F 18/2431; G06N 3/04

(57) ABSTRACT

A method for document classification is described. A first dataset of labeled corporate data, a second dataset of internal labeled documents for a customer, and a third dataset of unlabeled documents for the customer are obtained. A classification model is trained using the first dataset. The classification model is further trained using the second dataset. Feature extraction is performed on each of the unlabeled documents of the third dataset by vectorizing content and metadata of each unlabeled document into one or more vectors and concatenating the one or more vectors to obtain a fixed length vector. Each of the unlabeled documents of the third dataset is clustered into one or more clusters based on similarity between the fixed length vectors for each unlabeled document. The unlabeled documents in each of the clusters are automatically labeled using text summarization. The classification model is retrained using the automatically labeled documents.

### PRIORITY CLAIM

This application is a continuation application of U.S. patent application Ser. No. 16/731,259 filed Dec. 31, 2019 entitled “Deep Learning Engine and Methods for Content and Context Aware Data Classification,” which claims the benefit of and priority to Singapore Patent Application No. 10201811839R filed on 31 Dec. 2018, each of which is incorporated by reference herein in its entirety.

### TECHNICAL FIELD

The present invention relates generally to data management, and more particularly relates to deep learning and active learning methods and engines and file and record management platform systems for content and context aware data live classification.

### BACKGROUND OF THE DISCLOSURE

To protect sensitive information, and to meet regulatory requirements imposed by different jurisdictions, more and more organizations' electronic documents and e-mails (“unstructured data”) need to be monitored, categorised, and classified internally. Solutions for such monitoring, categorization and classification require time for inference and training of a model solution and be scalable for performing predictions on the large numbers of documents maintained by such organizations.

Such solutions need to satisfy three criteria. They need to have high accuracy (i.e., correct predictions vs. all predictions), high speed and low computing cost (i.e., the computing time required to train the models). Few solutions in this area today offer high prediction accuracy while having high execution speed and low computing cost. In addition, each organization has different requirements and capabilities for their document and data management system. If a solution cannot be adaptable to such differences and able to easily integrated into such systems, it will be difficult to manage the sensitive data management capabilities required by regulations in various jurisdictions

Thus, there is a need for a fast and accurate data management system for regulation-compliant management of sensitive personal data which is adaptable to the vagaries of various data management systems while being scalable to large data management systems and able to address the above-mentioned shortcomings. Furthermore, other desirable features and characteristics will become apparent from the subsequent detailed description and the appended claims, taken in conjunction with the accompanying drawings and this background of the disclosure.

### SUMMARY

According to at least one embodiment of the present invention, a deep learning engine is provided. The deep learning engine includes a feature extraction module and a classification and labelling module. The feature extraction module extracts both context features and document features from documents and the classification and labelling module is configured for content and context aware data classification of the documents by business category and confidentiality level using neural networks.

According to another embodiment of the present invention, a system for for context and content aware data classification by business category and confidential level is provided. The system includes a deep learning engine and a smart sampling module. The smart sampling module samples a pool of documents to identify documents or records for content and context aware data classification and the deep learning engine includes a feature extraction module and a classification and labelling module. The feature extraction module extracts both context features and document features from the documents or records and the classification and labelling module is configured for the content and context aware data classification of the documents or records by business category and confidentiality level using neural networks.

According to a further embodiment of the present invention, a method for content and context aware data classification by business category and confidentiality level is provided. The method includes scanning one or more documents or records in one or more data repositories of a computer network or cloud repository and extracting content features and context features of the one or more documents or records utilizing deep learning technologies as convolutional neural networks to associate the documents or records with one or more business categories and one or more confidentiality levels.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments and to explain various principles and advantages in accordance with a present embodiment.

FIGS. 1A and 1B depict flowcharts of operation of a deep learning system for document classification in accordance with present embodiments, wherein FIG. 1A depicts operation of initial prediction and construction of a model for document classification and FIG. 1B depicts predictions of new documents used in the trained model of FIG. 1A.

FIGS. 2A and 2B depict classification processes in accordance with the present embodiments, wherein FIG. 2A depicts a first flow of classification processes and FIG. 2B depicts a second flow of classification processes with improvements to two areas of the classification processes of FIG. 2A.

FIG. 3 depicts a flow diagram of a BERT architecture for supervised classification in accordance with the present embodiments.

FIG. 4 depicts an illustration of pool-based sampling active learning in accordance with the present embodiments.

FIG. 5 illustrates an active learning approach for classification in accordance with the present embodiments.

FIG. 6 depicts a graph of F1 scoring over time and data volume of the classification processing in accordance with the present embodiments.

FIG. 7 illustrates a classification model lifecycle in accordance with the present embodiments.

FIG. 8 illustrates confidence level as a function of solution completeness of the classification process in accordance with the present embodiments.

FIG. 9 is a graph of accuracy of BERT on a validation dataset in accordance with the present embodiments.

And FIG. 10 is a graph of accuracy of BERT over time in accordance with the present embodiments.

Skilled artisans will appreciate that elements in the figures are illustrated for simplicity and clarity and have not necessarily been depicted to scale.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description. It is the intent of the present embodiments to present systems and methods which combine deep learning, machine learning and probabilistic modelling using big data technologies to protect sensitive information and meet regulatory requirements imposed by different jurisdictions.

According to a first aspect of the present embodiments, a method for content and context aware data classification by business category and confidentiality level is provided. The method includes scanning one or many documents or records in one or more data repositories of a computer network or cloud repository and extracting content features and context features of the one or more documents or records for further online and offline classification. The solution leverages deep learning technologies as convolutional neural networks to associate the documents with one or more business categories and confidentiality level. Word embedding vectors in combination with metadata and data type vectors are created in a feature extraction step to be used for model training. The word embedding vectors are created for each language separately. Active Learning techniques are leveraged for accuracy optimization throughout the validation process.

According to another aspect of the present embodiments, a deep learning engine for content and context aware data classification is provided. The deep learning engine includes a model training module, a model validation/evaluation module and a data classification engine. The model training module is configured to predict one or many business categories based on word embedding vectors of context and content for each document or record, including numerical vectors in a raw training set. The model validation/evaluation module is developed to send samples of the documents with the predicted category and confidentiality to a data management system (e.g., an Oracle).

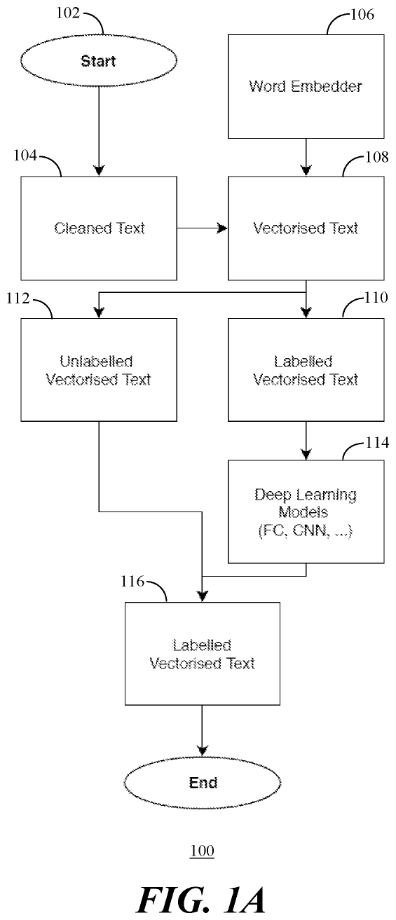

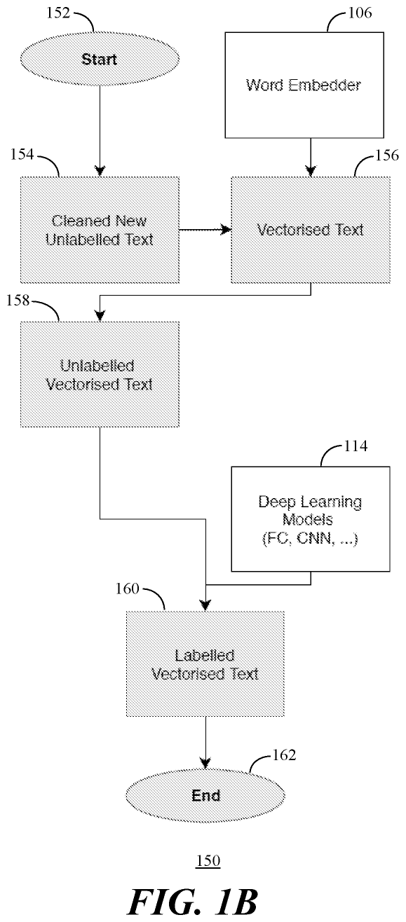

Referring to FIGS. 1A and 1B, flowcharts 100, 150 illustrate operation of a deep learning system for document classification in accordance with the present embodiments. Referring to the flowchart 100, an operation of initial prediction and construction of a model for document classification in accordance with the present embodiments starts 102 by collecting documents of cleaned text 104. Using a word embedder 106, vectorized text 108 is generated from the cleaned text 104.

The data includes unlabeled documents and at least a small number of labelled documents and the data is split into labelled vectorized text 110 and unlabelled vectorized text 112. A seed is defined as a small labelled dataset of labelled vectorized text 110. The seed is used to train classification models (i.e., deep learning models 114 such as convolutional neural network models) that give a probabilistic response to whether text or a document should have a particular label. The deep learning models 114 are then used to label the unlabelled vectorised text to generate labelled vectorised text 116. This ends 118 the model training phase.

Referring to the flowchart 150, once the model is trained, documents processing in accordance with the present embodiments starts 152 and can use the predictions from the deep learning models 114 to select documents of unlabelled text using pool-based sampling methodologies and convert them to documents of labelled vectorised text using a probability query strategy of the deep learning models 114 to add the documents to the labelled document dataset. For example, a batch size of documents for pool-based sampling is selected and cleaning is operated on the text 154 to obtain cleaned new unlabelled text. Next, the data is transformed into a meaningful numeric representation of vectorised text 156 by mapping of the text using the word embedder 106 to generate unlabelled vectorised text 158. The prediction needs to pass through fewer processes, using faster ones, as mapping of the text only needs to be done by the word embedder 106. Then vector representation of the text 156 is then passed to the network and obtain predictions for the new documents. The predictions are obtained by auto-labelling the unlabelled vectorised text 158 using the deep learning models 114 to create labelled vectorised text 160 in the documents in order to add the documents to a labelled dataset.

Selecting and converting unlabelled documents to labelled documents (i.e., steps 154, 156, 158 and 160) are repeated until a predefined stopping criteria is reached in order to end 162 the processing. Thus, when the stopping criteria (e.g., the number of documents to be queried) is reached, the new labelled dataset has been created.

In accordance with the present embodiments, machine learning and deep learning are used to train a classification model for a labelled dataset, which is collected before for a fixed list of category predictions (e.g., business category predictions). Next, the model is customized with specific labelled document cases for each client by using an active learning approach for new document selection for documents to be labelled. At the same time, new categories are added to the list of labels and the classifier can be retrained at each iteration. Clustering techniques can advantageously be used to minimize time for manual review.

So, in accordance with the present embodiments, a classification module is created to classify documents in a timely manner, to have a high accuracy for the classification task, and to be scalable for increasing number of documents or labels. However, such classification is complicated by the fact that the data in many of an organization's documents is industry specific data, there is a lack of labelled datasets, there are limitations in computation resources that can be devoted to the classification, and the data is multi-dimensional.

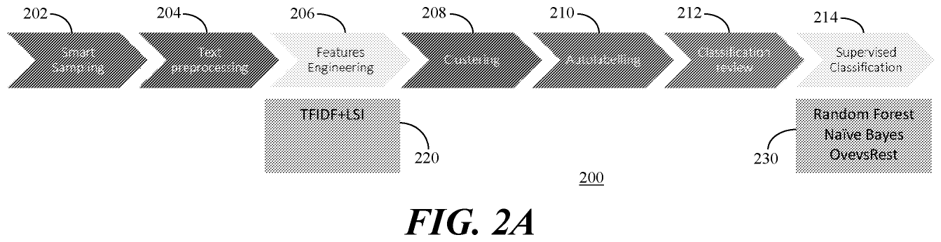

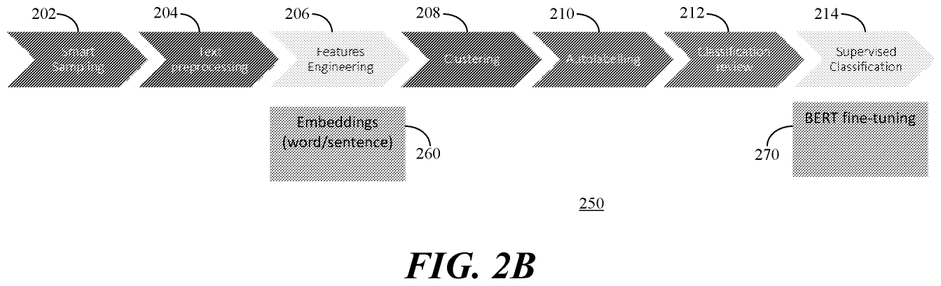

Referring to FIGS. 2A and 2B, flow diagrams 200, 250 depict classification processes in accordance with the present embodiments. Referring to the flow diagram 200, a supervised classification approach for classifying a data pool of documents uses smart sampling 202 followed by text preprocessing 204 and feature engineering 206. The documents are then clustered 208 and autolabelled 210. The classification of the labelled documents is reviewed 212 and then supervised classification 214 is performed.

The supervised classification approach uses term frequency-inverse document frequency (TF-IDF) and latent semantic indexing (LSI) 220 for feature engineering 206. TF-IDF is a numerical statistic that is intended to reflect how important a word is to a document in a collection or dataset. The TF-IDF value of a document increases proportionally to a number of times a word appears in the document and is offset by the number of documents in the dataset that contain the word. LSI is an indexing and retrieval method that uses singular value decomposition to identify patterns in relationships between terms and concepts contained in an unstructured collection of text.

Supervised collection 214 is performed by one or more of Random Forest decision tree classification, Naïve Bayes probabilistic classification, one-vs-the-rest (OnevsRest) classification or one-vs-all classification or XGBoost 230. However, the TF-IDF and LSI 220 and the Random Forest, Naïve Bayes, OnevsRest and XGBoost 230 have issues with both speed and accuracy. Many of the speed issues result from the TF-IDF and LSI models for feature engineering being trained on the client side. In regards to accuracy, the quality of prediction arises to only around seventy percent an is dependent upon the organization and the documents (i.e., varies from client to client)

Referring to the flow diagram 250, an improved classification process in accordance with the present embodiments is depicted. For feature engineering, the TDF-IF and LSI approach 220 is replaced by an embedding approach 260 for embedding words or sentences. The supervised classification 214 is improved by a Bidirectional Encoder Representations from Transformers (BERT) fine-tuning supervised classification approach 270. The advantage of the classification process of the flow diagram 250 is increased accuracy and speed, improved scalability and ease of adaptation to an organization's data distribution through ease of development using a Spark machine learning library and the ability for customization. However, there are no deep learning libraries for Spark or Scala.

The advantages are that pretrained models are provided for vectorization, removing the need for training and the need to reset training when a new batch of documents is addressed. In addition, accuracy is improved due to the more sophisticated models used. Labeling time is reduced as less data points are needed per class. Using the pretrained vectorization models provides more control over the vectors including their shape and the pooling strategies used. Finally, there is no limit on vocabulary and multiple languages are supported.

In order to obtain these advantages, the improved classification process is computationally costly and requires increased disk space.

The changes as seen in the classification process flow diagram 250 are that the TF-IDF and LSI 220 are replaced by an embedding model 260 and the legacy classifiers 230 are replaced by the fine-tuned BERT 270. With the embedded model 260, both metadata and content can be used for vectorization. In addition, the vectors and be concatenated or a pooling over the data can be performed to obtain a fixed length vector. As the embedded model 260 can be fine-tuned in an unsupervised method, there is no need for labels.

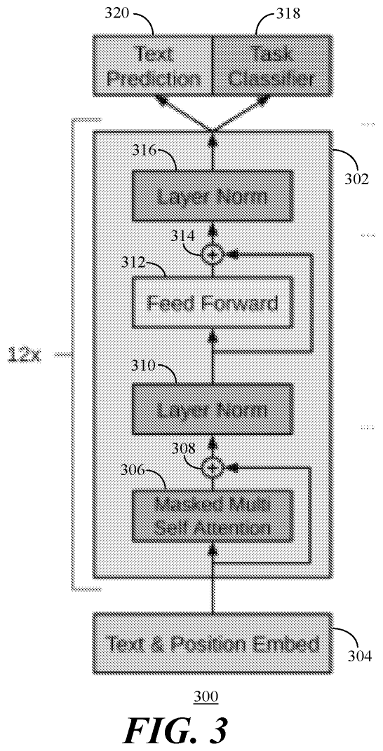

In regards to the fine-tuned BERT, it can be fine-tuned in order to perform document classification. Dataset input including cleaned text and uncleaned text can be accommodated because BERT greedily breaks down unknown words to subwords removing the need for lemmatization, however labeled datasets with categories are preferred. Referring to FIG. 3, a flow diagram 300 depicts a BERT architecture for supervised classification in accordance with the present embodiments. The BERT architecture (Bidirectional Encoder Representations from Transformers) includes a transformer architecture 302 having a feed-forward neural network with layer norm and multi-head attention. Text and position embedded data 304 is provided to the transformer architecture 302 and the multi-head attention is addressed at a masked multi-self attention step 306 after which the output of step 306 is combined 308 with the input of step 306. The layer norm 310 processes the data and provides it to a feed forward step 312 after which the output of step 312 is combined 314 with the input of step 312 before a second layer norm step 316 is performed. Task classification 318 and text prediction 320 can then be performed. The architecture has residual connections for better learning and uses the layer norm 310, 316 for better training

The training of BERT is based on two tasks: masked machine learning and next sentence prediction as seen in the Example (1) below where sentence prediction of the first input predicts that the second sentence is a next sentence while sentence prediction of the second input predicts that the second sentence is not a next sentence.

$$Input = ( CLS ) the man went to ( MASK ) store ( SEP ) he bought a gallon ( MASK ) milk ( SEP ) \qquad ( 1 )$$

$$Label = IsNext$$

$$Input = ( CLS ) the man ( MASK ) to the store ( SEP ) penguin ( MASK ) are flight ** less birds ( SEP )$$

$$Label = NotNext$$

In regards to document input for the BERT fine-tuning 270 (FIG. 2B), no feature engineering is required; the input could be from document head, middle or tail; the document clipping can be done at a sequence length; depending on the BERT model used, there can be different layers (e.g., 11 or 24), more layers can be added (e.g., when the number of categories is changed), and the category probability is outputted form each layer; the weights of parameters are loaded from a pre-trained BERT model; the sum over the categories is equal to one so top 1, top 3, or top 5 predictions can be used; and the confidence level can be calculated on the categories.

One of the disadvantages of the classification process 250 is that it relies on a large number of labeled samples, which is expensive and time-consuming to obtain. Active learning (AL) aims to overcome this issue by asking the most useful queries in the form of unlabeled samples to be labeled. In other words, active learning intends to achieve precise classification accuracy using as few labeled samples as possible. This approach is attractive in scenarios in which labels are expensive but unlabeled data is plentiful.

So, active learning can be used in conjunction with transfer learning to optimally leverage existing (and new) data. Suppose, for example, that there are two clusters. As the samples are already labelled it is simple a classification problem which can be solved by leveraging supervised machine learning or deep learning techniques. However, what would happen if the labels of the data points are not known? The process of manual labeling of the whole dataset would be very expensive. As a result, sampling of a small subset of points and finding the labels and using the labeled data points as our training data is desired for a classifier.

Logistic regression could be used to classify the shapes by first randomly sampling a small subset of points and labelling them. However, the decision boundary created using logistic regression may too near one set of data points and/or too far from another set of data points. In this case, the accuracy of prediction will not be high as data points from one set will be classified as data points of the other set. This is due to poor selection of data points for labelling.

When logistic regression is used with a small subset of points selected using an active learning query method, the decision boundary is significantly improved. This improvement comes from selecting superior data points so that the classifier is able to create a good decision boundary. This results from the hypothesis in active learning that if a learning algorithm can choose the data it wants to learn from, it can perform better than traditional methods with substantially less data for training.

In order to better understand this hypothesis, it is necessary to distinguish between passive learning and active learning. Passive learning, which can be termed a traditional method, supposes that a large amount of data is randomly sampled from an underlying data distribution and this large dataset is used to train a model that can perform some sort of prediction. Active learning is a method for sampling data by defining certain criteria for sampling instead of a random selection of criteria. For instance, when classifying text documents into two Business categories (e.g., a finance category including financial reporting and an employee category including employees' salaries and rewards), rather than selecting all the documents at random, criteria can be specified like the documents might be in csv or excel format and contain numbers. This criteria does not have to be static but can change depending on results from previous documents. For example, if you realized that your model is good at predicting the finance category for xlsx documents, but struggles to make an accurate prediction for csv documents, the criteria can be adjusted to reflect this.

Active Learning may include scenarios such as membership query synthesis, stream-based selective sampling and pool-based sampling. The idea behind membership query synthesis is simply generating samples from an underlying distribution of data and sending the samples for manual or automatic labelling. By using stream-based selective sampling, one sample can be selected from an unlabelled dataset, it is determined whether the sample needs to be labelled or discarded, and then the steps are repeated with a next sample. In regards to pool-based sampling, suppose that from a large amount of unlabelled data (e.g., a pool of data), only the most informative instances according to some defined metrics are to be selected and then a request is made to label them. For example, when documents are to be classified, select those which are in defined formats with a specified percentage of numbers.

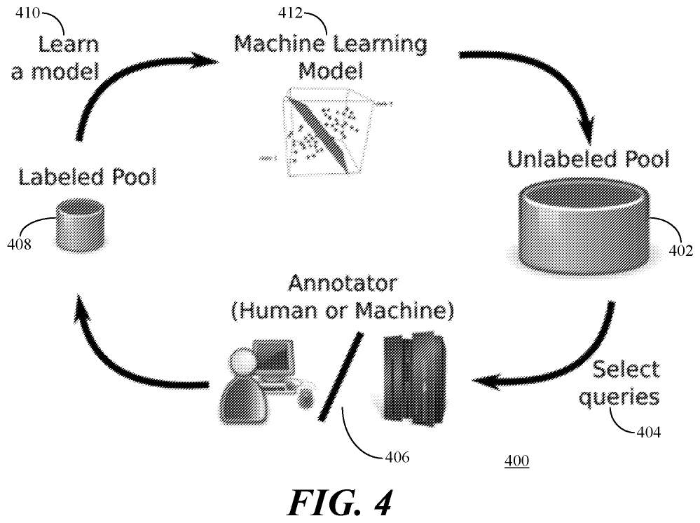

This last active learning methodology, pool-based sampling, is the most common active learning methodology. Referring to FIG. 4, an illustration 400 depicts pool-based sampling active learning in accordance with the present embodiments. From an unlabelled pool of data 402, queries are selected 404 and validated by an annotator 406 which can either be a human annotator or a machine annotator. The queries 404 refine the pool of data to a labelled pool of data 408 which is used to learn 410 a machine learning model 412 and the process is repeated.

The main or core difference between active learning and passive learning is the ability to query samples based upon past queries and the responses (labels) from those queries. All active learning scenarios require some sort of informativeness measure of the unlabeled instances. There are three popular approaches for querying samples under a common topic called uncertainty sampling due to its use of probabilities. With least confidence sampling, the learner 406 would select a document to query based on its actual label when the actual label indicates the document has a smallest confidence in the data pool prediction. For margin sampling, a difference between first and second most probable labels is taken into account. For entropy sampling, entropy is calculated for probabilities and the document with the largest entropy is selected.

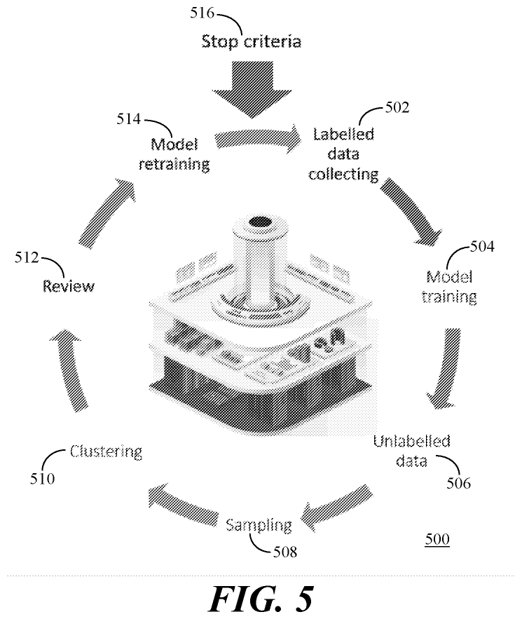

Referring to FIG. 5, an illustration 500 depicts an active learning approach for classification in accordance with the present embodiments. Labelled data is collected 502 and a model is trained 504. Machine learning and deep learning are used to train the model on the labelled dataset, which is collected before for a fixed list of category predictions. In addition, an existing model is customized with specific cases for each client by using an active learning approach for selection of new documents to be labelled. At the same time, new categories are expected to be added to the list of labels and retraining the classifier is expected on each iteration. At step 504, a list of business categories such as levels of confidentiality are collected and the label data 502 for each category and training the classification model 504 are used with the next steps. Both, machine learning and deep learning models 504 could be pretrained and used depending on timing and computation requirements.

As pool-based sampling was considered, the pretrained model is run for the prediction on client's unlabelled dataset 506 and the probabilities for each label per each document are obtained. The documents specific for the client are sampled 508 and a least confidence strategy is used for identifying “bad” samples to determine which documents should be reviewed or even classified in another category.

Taking into account the huge amount of unlabelled data, it is expected to derive a lot of unlabelled samples. Thus, the next step is to use clustering 510 to group the documents by their similarity and to be able to sample subclusters during a reviewing step 512. In this manner, the clustering techniques 510 are used to minimize time for manual review 512. During the review step 512, manual review or auto-labelling by using text summarization methods is applied to obtain a label for new samples. At step 514, the machine learning or deep learning classification model is retrained with new labelled samples and processing returns to collect 502 labelled data. These processes are continued until a predefined stopping criteria is satisfied 516. For example, the predefined stopping criteria could be the number of unlabelled samples processed.

The disadvantage of deep learning is that it requires a large amount of labelled data to provide good performance. So, in order to make the best use of deep learning when annotation resources are scarce, the objective for active learning in accordance with the present embodiments should primarily be to select samples/documents that result in better representations.

The goal of document classification is to assign one or more labels to each document. One way of doing this task is in a supervised method, meaning that a model is trained for the specific task of giving a set of defined categories to documents. Having a model to classify documents is efficient. Thus, the problem of finding a document's category and confidentiality can be formulated as a classification problem.

By this formulation, the aforementioned supervised algorithms to can be used to classify the documents. According to recent studies, deep learning methods have made a significant improvement on traditional machine learning approaches. However, the deep learning methods require huge amounts of data, resulting in a challenge in real world applications. Even though there are publicly available models, using them directly is also problematic where data can vary due to industry differences and client specific requirements. This raises the question “How can a deep learning method be trained with a low number of labelled data?”. In accordance with the present embodiments, a transfer learning approach can advantageously be used to answer this question. Transfer learning utilizes general linguistic knowledge learned by publicly available deep-learning models to build a customized classifier for specific use-cases with much less labelled data or no data at all.

Two types of input data are needed for different stages of our methodology. The first type of data consists of general labelled corporate data which can be built from the internet and a dataset of standard documents. The second type of data should be a small set of the clients' own labelled documents that have been manually reviewed. The transfer learning approach in accordance with the present embodiments consists of two stages. First, a general classifier is built using a first type of data, where the language model will learn to do a classification task and familiarize itself with general corporate data. At a second stage, the classifier will be further trained (or fine-tuned) on a second type of data to fit customer needs.

According to multiple studies, the transfer learning approach can deliver close to state-of-the-art performance with much less labelled data by utilizing easily accessible general data. Hence, using the transfer learning approach helps to free clients from a cumbersome and expensive task of labelling tremendous amounts of documents and other kinds of data for a classification task.

For confidentiality prediction in accordance with the present embodiments, six label classifications correspond to the following levels of confidentiality: top secret, secret, confidential, internal, public and private. Combinations of these labels are possible, but there is a clear hierarchy between a few of them such as top secret and secret. On top of that, the confidentiality status of a file may change over time such as, for example, a product description before and after the product is publicly revealed.

Measuring the success of a model should be business use case specific. Accordingly, the accuracy or F1-score may be used to judge whether a model is qualitatively good or not. However, confidentiality is different. For example, if a public document is misclassified as secret, the impact is minimal: in other words, being wrong on the public label is much less impactful than being wrong on a secret or top secret label. Accordingly, one can be less precise and “miss” some public documents but not more confidential ones. The impact of classification errors can be weighted by label to achieve better results. This means that classification errors can be performance class-based instead of task-based and an unbalanced loss function will then be used to compute gradient updates.

There is also another way to look at this classification problem: what if a top secret document is misclassified as a secret document? In that case, an error has been made, but clearly a less important error than if the document was classified as public.

In accordance with the present embodiments, the classifier is designed in two ways to take this into account. The first way is to measure success in a custom way, for example, by label and by “distance” from a right label. The second way is to arbitrarily change the classifier to allow for a custom way to classify, for example, where a probabilistic property of the model is a highly desirable property.

Take an example of a model prediction for a specific file with the following probabilities of it belonging to any of the six classes: top secret: 0.3%; secret: 0.1%; confidential: 0.01%; internal: 0.09%; public: 0.5%; and private: 0%. In this case, the most probable label is public, however the probability of it being top secret is high. So a cutoff can be defined: for example, arbitrary rules like “if the probability of the file being top secret is higher than 20%, classify it as top secret”. A list of domain-expert created rules might be the way to go as they are the only ones able to quantify how many errors of that type should be allowed.

In accordance with the present embodiments, the accuracy is measured using a F1-score for all confidentiality classes except the public one, as the accuracy of how a public record/document is classified is typically of little concern. There are two ways to use the F1-score: a macro F1-score and a micro F1-score. The macro F1-score is defined as the average of all F1-scores computed class-wise. The micro F1-score is defined as the weighted mean of all F1-scores computed class-wise, and this is more suited to the task at hand, as misclassifying secret documents is worse than misclassifying internal ones. In accordance with an aspect of the present embodiments, the weights used for the weighted mean of the F1-scores computed class-wise are: secret is assigned a weight of 50%, confidential is assigned a weight of 33.33%, internal is assigned a weight of 16.66%, and public is assigned a weight of 0%.

We now need to have a broad understanding of what the classification engine in accordance with the present embodiments is capable of extracting from documents and files. From analyzing a file or analyzing its metadata the following information may be extracted: type of document, creation date, a boolean indicating whether the file contains PIIS or not, language, last modification date, last user that modified the document, a complete list of metadata, an owner of the file, a file path on the client's machine, size of the file in bytes; a boolean indicating whether the file is encrypted or not, two levels of business categories, and a confidentiality category labeled by a domain expert.

Next, PIIS can be detected and linked to a specific file and PII type (e.g., email, credit card number). For each folder, the size, the number of files in the folder, the number of folders, and the file path are known. And a vectorized version of the metadata weighting twenty-six information per file is known. All of these data points can be leveraged to either create new features or to directly plug existing ones into a classifier.

As discussed hereinabove, one of two main bottlenecks with the deep learning approach is its need for huge data. To fill this gap, during recent years transfer learning is gaining popularity. Transfer learning attempts to utilize knowledge learned by one model in one domain to another with the goal of reducing the size of new training data. For a document classification task, transductive transfer learning is used where the feature spaces between domains are the same, XS=XT, but the marginal probability distributions of the input data are different, P(XS)=P(XT). Recent transductive transfer learning approaches on deep learning methods could be grouped into four types: instance-based learning, mapping based learning, network based learning and adversarial based learning.

Instance based learning (ITL) (i.e., instances-based deep transfer learning) refers to using a specific weight adjustment strategy and selecting partial instances from a source domain as supplements to a training set in a target domain by assigning appropriate weight values to the selected instances. Thus, ITL methods should be considered when target and source domain distributions are similar.

Mapping based learning (MTL) (i.e., mapping-based deep transfer learning) refers to mapping instances from a source domain and a target domain into a new data space. In this new data space, instances from two domains are similarly and suitable for a union deep neural network.

Network based learning (NTL) (i.e., network-based deep transfer learning) refers to reuse of a partial network that is pre-trained in a source domain, including its network structure and connection parameters, by transferring it to a part of deep neural network which is used in a target domain.

Adversarial based learning (ATL) (i.e., adversarial-based deep transfer learning) refers to introducing adversarial technology inspired by generative adversarial nets (GAN) to find transferable representations that are applicable to both a source domain and a target domain.

To track and evaluate research progress and measure value, a solid benchmark of systems and methods on current research environment is necessary. Since the pipeline process includes TF-IDF vectorization followed by dimensionality reduction techniques for feature extraction and various types of classification algorithms, an examination of various types of dataset methodologies our examined.

An overview of the process includes four stages: pre-processing text, TF-IDF extraction, dimensionality reduction, and classifying. The pre-processing steps include stop-word removal, lemmatization and tokenization. Then, normal TF-IDF with dimensionality reduction by singular value decomposition is used to create document embeddings. And finally, various classifiers have been tested including those supported in accordance with the present embodiments. To extract features from a document, we used As TF-IDF followed by the dimensionality reduction technique of singular value decomposition is used to extract features from a document, every document in the dataset is converted into a vector of eighty dimensions. The classification accuracies of different models over reduced vectors of different datasets are reported in Table 1.

TABLE 1

| | 20 news- | | | 20 ng |
|---|---|---|---|---|
| Model | group | UMLI01 | UMLD01 | tf-idf |
| Ridge | 0.78 | 0.85 | 0.86 | 0.90 |
| Classifier | | | | |
| Perceptron | 0.69 | 0.82 | 0.82 | 0.91 |
| Passive | 0.79 | 0.86 | 0.86 | 0.90 |
| Aggressive | | | | |
| Classifier | | | | |
| KNeighbors | 0.76 | 0.87 | 0.79 | 0.82 |
| Random Forest | 0.81 | 0.87 | 0.79 | 0.87 |
| Multi-Layer | 0.85 | 0.875 | 0.87 | 0.93 |
| Perceptron | | | | |
| Decision Tree | 0.61 | 0.84 | 0.74 | 0.68 |
| OneVsRest | 0.7 | 0.84 | 0.84 | 0.9 |
| GradientBoosting | 0.79 | 0.81 | 0.79 | 0.84 |
| Linear SVC | 0.83 | — | 0.878 | — |
| SGD | 0.79 | — | 0.88 | — |
| Nearest Centroid | 0.76 | — | 0.77 | — |
| MultinomialNB | 0.44 | — | 0.28 | — |
| BernoulliNB | 0.04 | — | 0.15 | — |

Turning now to the BERT model fine-tuning with industry-specific unstructured documents by using content features, it is noted that during fine-tuning, the entire model is optimized end-to-end, with additional soft-max classifier parameters. In addition, the cross-entropy and binary cross-entropy loss are minimized for single-label and multi-label tasks, respectively. Further, accuracy of results on datasets can be used to fine-tune the BERT model. Other than accuracy, another important criteria is how many datapoints are minimally required to train deep-learning models.

Active learning answers the critical question: “what is the optimal way to choose data points to label such that the highest accuracy can be obtained faster?” and promises to guide annotators to examples that bring the most value for a classifier. The main idea is adding a minimum number of the most informative samples from a target domain to a training set, while removing source-domain samples that do not fit with distributions of classes in the target domain.

The key point of active learning is its sample selection criteria. In accordance with the present embodiments, a pool-based approach is used which optimizes active learning with smart selection algorithms for not confident samples selection. Not confident samples are documents which have a high probability of few labels (e.g., pay slips and medical records). As soon as the samples are reviewed by human, the model is retrained again.

Thus, an initial neural network can be trained on a small dataset and the learned embeddings at the last hidden layer are taken as representative. Clustering may then be performed and the samples with the lowest silhouette score are considered as the most uncertain for the model.

Confidence level is a measurement which helps to understand how confident a model is for a certain prediction. The continuous measurements of the level of confidence in a prediction helps a model make the decision about the next step of the process. For example, if a new dataset is added and run for classification, whether the new documents are following the same distribution as the set of the unstructured documents can be measured. Or, if a model is performing well on metadata used for a classification goal, a higher weight can be put on the metadata features for the next step. The methodology in accordance with the present embodiments helps scalability of the present systems and methods in terms of data volume and quality of the classification.

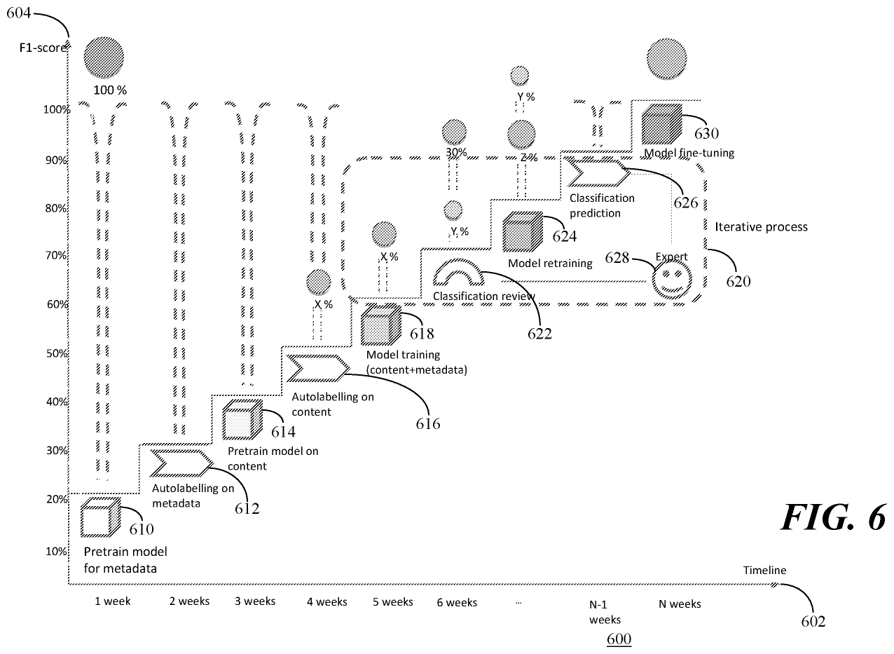

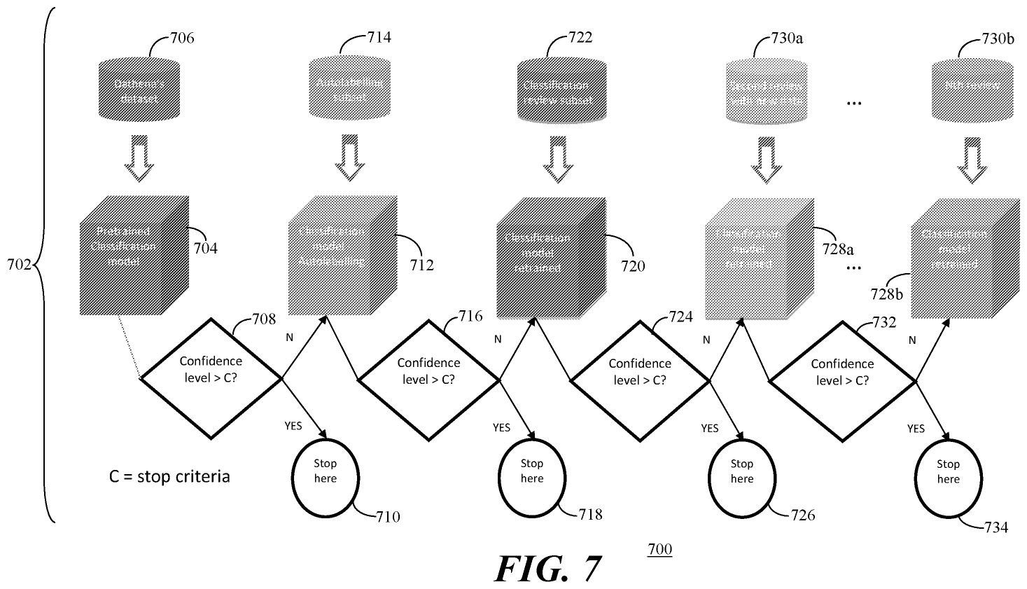

Referring to FIG. 6, a graph 600 depicts F1 scoring over time and data volume of the classification processing in accordance with the present embodiments. Time is plotted along the x-axis 602 and the F1-score is plotted along the y-axis 604. Initially, models are pretrained 610 for metadata. Then, autolabelling 612 of metadata is performed. Then models are 614 pretrained for content and autolabelling 616 of content is performed.

After model training 618 for content and metadata is performed, an iterative process 620 of classification review 622, model retraining 624 and classification 626 is performed with an expert/annotator 628 performing the classification review 626 and the classification prediction 626. At the end of the process, the model is fine-tuned 630.

As seen from the graph 600, the F1-score improves with each step in the process and the fine-tuning 630 approaches an F1-score of 100%. The pretrained models 610, 614 could be specified by category. In addition, other dimensionalities are possible such as confidentiality level, integrity, export control or military. Smart sampling is used to select the most representative samples for the autolabelling 612, 616. In addition, smart sampling is used to select the most representative and uncertain samples for classification review 622. Data augmentation methods may be used to oversample a training dataset after the classification review 622. The model retraining process 624 is repeatable as soon as new data is added or a minimum reviewed subset is built.

Referring to FIG. 7, an illustration 700 depicts a classification model lifecycle 702. A pretrained classification model 704 is pretrained on a balanced dataset 706, balanced per business category. If the pretraining 704 results in a confidence level greater than a predetermined stop criteria 708, the processing stops 710. Otherwise, classification model autolabelling 712 is performed on an autolabelling subset 714. The autolabelling subset 714 contains the most representable samples of the balanced dataset with the highest confidence level and can include new business categories. If the autolabelling 712 result s in a confidence level greater than a predetermined stop criteria 716, the processing stops 718.

Then, the classification model is retrained 720 a first time on a classification review subset 722. The classification review subset 722 includes the most uncertain samples reviewed by an expert. If the classification model retraining 720 results in a confidence level greater than a predetermined stop criteria 724, the processing stops 726. Otherwise, classification model retraining is repeated 728 a, 728 b on new data 730 a, 730 b for each review. A minimum amount of documents per business category are defined as the new data 730 a, 730 b to retrain 728 a, 728 b the classification model after each review. When the classification model retraining 728 a results in a confidence level greater than a predetermined stop criteria 732, the processing stops 734.

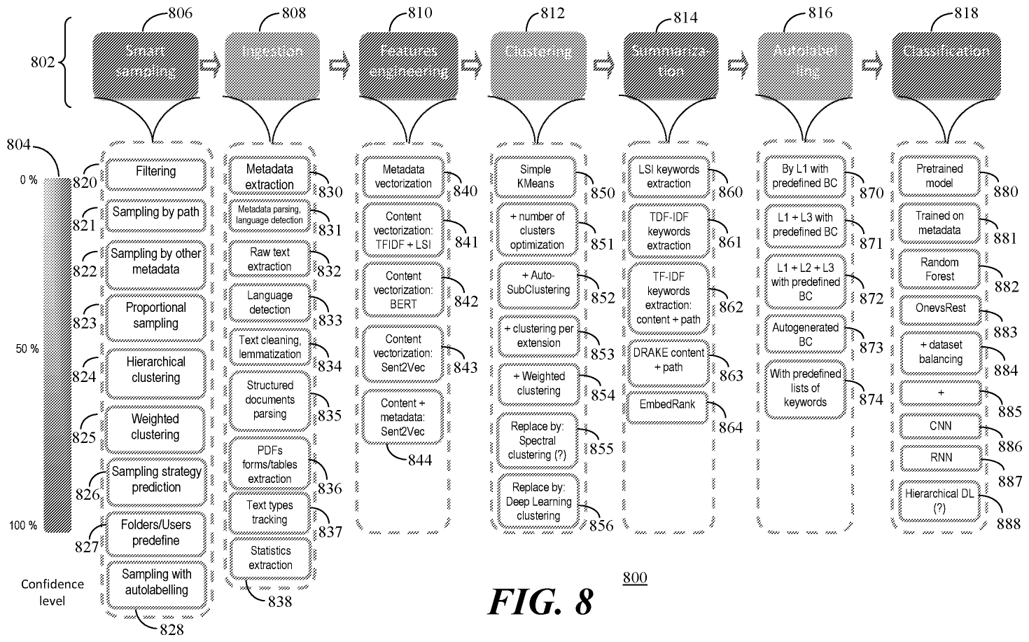

Referring to FIG. 8, an illustration 800 confidence level as a function of solution completeness of the classification process 802 in accordance with the present embodiments. The confidence level meter 804 measures the confidence level at each subprocess of the classification process. The classification process 802 includes smart sampling 806, data ingestion 808, features engineering 810, clustering 812, summarization 814, autolabelling 816 and classification 818.

The smart sampling 806 includes nine subprocesses of increasing confidence from around 0% to 100%: filtering 820, sampling by path 821, sampling by other metadata 822, proportional sampling 823, hierarchical clustering 824, weighted clustering 825, sampling strategy prediction 826, folder users predefine 827 and sampling with autolabelling 828.

The data ingestion 808 includes nine subprocesses of increasing confidence from around 10% to 100%: metadata extraction 830, metadata parsing/language detection 831, raw text extraction 832, language detection 833, tex cleaning/lemmatization 834, structured documents parsing 835, PDFs forms/tables extraction 836, text types tracking 837 and statistics extraction 838.

The features engineering 810 includes five subprocesses of increasing confidence from around 40% to 90%: metadata vectorization 840, content vectorization (TD-IDF and LSI) 841, content vectorization (BERT) 842, content vectorization (Sent2Vec) 843 and content and metadata (Sent2Vec) 844.

The clustering 812 includes seven subprocesses of increasing confidence from around 30% to 100%: simple k-means 850, plus number of clusters optimization 851, plus auto-subclustering 852, plus clustering per extension 853, plus weighted clustering 854, replace by spectral clustering 855 and replace by deep learning clustering 856.

The summarization 814 includes five subprocesses of increasing confidence from around 40% to 90%: LSI keywords extraction 860, TDF-IDF keywords extraction 861, TDF-IDF keywords extraction including content and path 862, DARKE content and path 863 and EmbedRank 864.

The autolabelling 816 includes five subprocesses of increasing confidence from around 40% to 90%: autolabelling by L1 with predefined business categories 870, autolabelling by L1 and L3 with predefined business categories 871, autolabelling by L1 and L2 and L3 with predefined business categories 872, autogenerated business categories 873 and autolabelling with predefined lists of keywords 874.

The classification 818 includes nine subprocesses of increasing confidence from around 0% to 100%: pretrained model 820, trained on metadata 881, Random Forest 882, OnevsRest 883, plus dataset balancing 884, plus 885, convolutional neural network 886, recurrent neural networks 887 and hierarchical deep learning 888.

In regards to evaluation metrics defined for the deep learning approach in accordance with the present embodiments, accuracy is defined as the number of correct predictions over all predictions. The balanced accuracy in binary and multiclass classification problems is utilized to deal with imbalanced datasets and is defined as the average of recall obtained on each class. The best value is one and the worst value is zero when adjusted. Loss is a measurement of cross-entropy loss.

A further metric is a Chinzorig-Rahimi uncertainty metric which shows a relative performance of the classifier in accordance with the present embodiments as compared to a uniform classifier.

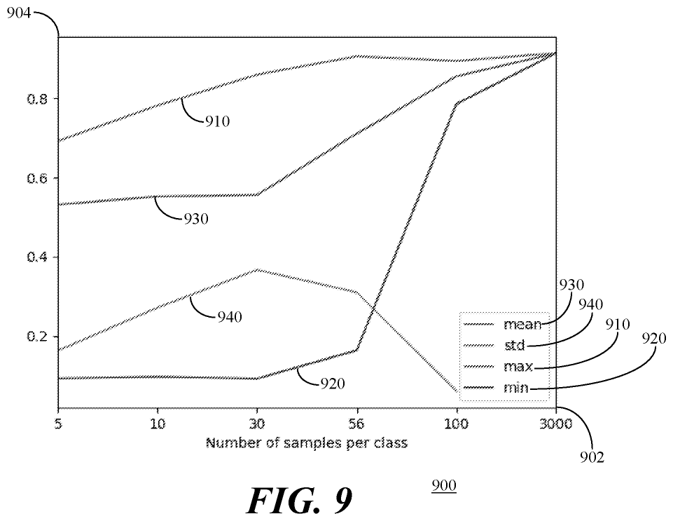

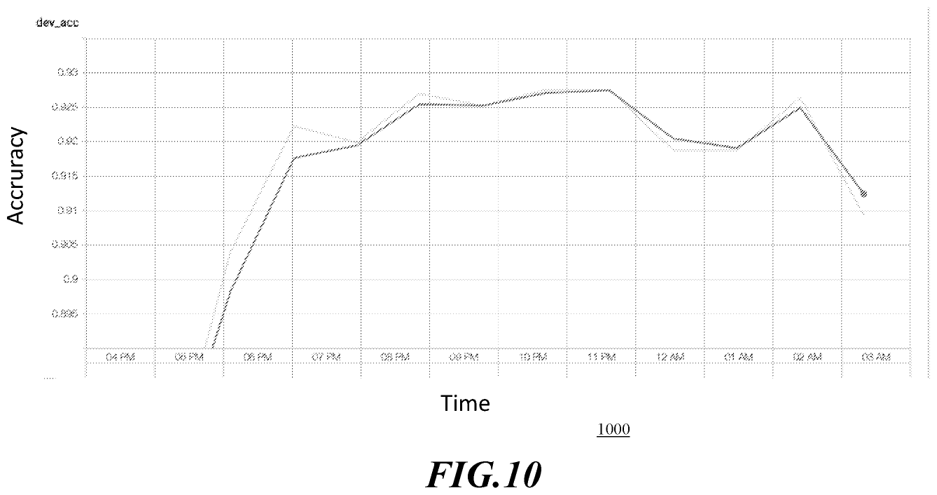

Referring to FIG. 9, a graph 900 depicts accuracy of BERT on a validation dataset in accordance with the present embodiments. The number of samples are plotted along the x-axis 902 and the accuracy is plotted along the y-axis 904. The graph 900 shows maximum accuracy 910 and minimum accuracy 920 as well as accuracy mean 930 and accuracy standard deviation 940.

Referring to FIG. 10, a graph 1000 of accuracy of BERT over time is depicted. Time is plotted along the x-axis 1002 in hours of a day and the accuracy is plotted along the y-axis 1004. The graph 1000 shows the accuracy 1010 of BERT.

Thus, it can be seen that the present embodiments provide a deep learning engine for content and context aware date classification of documents by business category and confidential status which outperforms similar solutions in terms of industry specific unstructured data classification due to a features engineering process which includes industry specific significant features leveraging and importance level calculations for each dimensionality, transfer learning for minimizing a size of training datasets and enabling continuous retraining, and active learning to enable users to convert their feedback into continuous model optimization and confidence level of the classification.

While exemplary embodiments have been presented in the foregoing detailed description of the invention, it should be appreciated that a vast number of variations exist. It should further be appreciated that the exemplary embodiments are only examples, and are not intended to limit the scope, applicability, operation, or configuration of the invention in any way. Rather, the foregoing detailed description will provide those skilled in the art with a convenient road map for implementing an exemplary embodiment of the invention, it being understood that various changes may be made in the function and arrangement of steps and method of operation described in the exemplary embodiment without departing from the scope of the invention as set forth in the appended claims.

What is claimed is:

1. A method for document classification comprising:
obtaining a first dataset of labeled corporate data;
obtaining a second dataset of internal labeled documents for a customer;
obtaining a third dataset of unlabeled documents for the customer;
training a classification model using the first dataset;
further training the classification model using the second dataset;
performing feature extraction on each of the unlabeled documents of the third dataset, wherein performing feature extraction comprises:
vectorizing content and metadata of each unlabeled document into one or more vectors; and
concatenating the one or more vectors to obtain a fixed length vector;
clustering each of the unlabeled documents of the third dataset into one or more clusters based on similarity between the fixed length vectors for each unlabeled document;
automatically labeling each of the unlabeled documents in each of the one or more clusters using text summarization; and
retraining the classification model using the automatically labeled documents.

2. The method of claim 1, wherein active learning is utilized to select which documents of the third dataset are to be labeled.

3. The method of claim 1, wherein the internal labeled documents have been manually labeled.

4. The method of claim 1, wherein vectorizing content and metadata of each unlabeled document is performed by a word embedder.

5. The method of claim 1, wherein the text summarization comprises:
sampling a subset of the unlabeled documents in a cluster with highest confidence levels to obtain a label for the cluster.

6. The method of claim 5, further comprising adding the label to a list of labels maintained for the customer if the label is not in the list of labels.

7. The method of claim 6, wherein the classification model is retrained whenever a new label is added to the list of labels.

8. The method of claim 1, wherein further training the classification model using the second dataset is performed using a bidirectional encoder representations from transformers (BERT) architecture.

9. The method of claim 8, wherein the BERT architecture comprises a transformer architecture having a feed-forward neural network with layer norm and multi-head attention, wherein text and position embedded data are provided to the transformer architecture.

10. The method of claim 9, wherein the layer norm processes the text and position embedded data utilizing feed forwarding to perform task classification and text prediction.

11. The method of claim 8, wherein the BERT architecture is trained based on masked machine learning and next sentence prediction.

12. The method of claim 1, further comprising utilizing the retrained classification model for labeling additional datasets of unlabeled documents for the customer.

13. A deep learning engine comprising:
a classification module configured to train a classification model using a first dataset of labeled corporate data and a second dataset of internal labeled documents for a customer;
a feature extraction module configured to:
vectorize content and metadata of each unlabeled document, of a third dataset of unlabeled documents for the customer, into one or more vectors; and
concatenate the one or more vectors to obtain a fixed length vector;
a clustering module configured to cluster each unlabeled document of the third dataset into one or more clusters based on similarity between the fixed length vectors for each unlabeled document; and
a labeling module configured to automatically label each of the unlabeled documents in each of the one or more clusters using text summarization.

14. The deep learning engine of claim 13, wherein active learning is utilized to select which documents of the third dataset are to be labeled.

15. The deep learning engine of claim 13, wherein the internal labeled documents have been manually labeled.

16. The deep learning engine of claim 13, wherein vectorizing content and metadata of each unlabeled document is performed by a word embedder.

17. A system for classifying unlabeled documents, the system comprising:
a deep learning engine comprising a classification module, a feature extraction module, a clustering module, and a labeling module, wherein the classification module is configured to train a classification model using a first dataset of labeled corporate data and a second dataset of internal labeled documents for a customer, wherein the feature extraction module is configured to:
vectorize content and metadata of each unlabeled document, of a third dataset of unlabeled documents for the customer, into one or more vectors; and
concatenate the one or more vectors to obtain a fixed length vector,
wherein the clustering module is configured to cluster each unlabeled document of the third dataset into one or more clusters based on similarity between the fixed length vectors for each unlabeled document, and wherein the labeling module configured to automatically label each of the unlabeled documents in each of the one or more clusters using text summarization; and
a smart sampling module configured to sample a pool of documents in one or more data repositories to identify documents for classification.

18. The system of claim 17, wherein active learning is utilized to select which documents of the third dataset are to be labeled.

19. The system of claim 17, wherein the internal labeled documents have been manually labeled.

20. The system of claim 17, wherein vectorizing content and metadata of each unlabeled document is performed by a word embedder.
